(19) United States
(12) Patent Application Publication
(10) Pub. No.: US 2015/0254771 A1
(43) Pub. Date: Sep. 10, 2015

(54) AUTOMATED MODEL RESTRICTION VERFICATION

(71) Applicant: Bank of America Corporation, Charlotte, NC (US)

(72) Inventor: Daniel Mayenberger, London (GB)

(73) Assignee: Bank of America Corporation, Charlotte, NC (US)

(21) Appl. No.: 14/198,850

(22) Filed: Mar. 6, 2014

(51) Int. Cl. G06Q 40/04

(52) U.S. Cl. CPC G06Q 40/04

(57) ABSTRACT

Apparatus and methods for automated model restriction verification are provided. Apparatus and methods may include introducing a dictionary of terms with respect to which a restriction imposed on a trade may be formulated. Illustrative restrictions may include a payoff currency of the trade must be in a G7 currency or a time to maturity of a trade must be at most 7 years. Apparatus and methods may utilize lexical items to formulate a formula expressing the restriction. Apparatus and methods may automatically parse the formula in response to receiving a trade. Apparatus and methods may include defining lexical items using technical function calls. Apparatus and methods may include formulating a restriction using a lexical item, and verifying syntactical correctness using sample values. Apparatus and methods may include automated verification of the restriction to assert adherence to restriction.

### FIELD OF TECHNOLOGY

Aspects of the invention relate to verifying one or more restrictions associated with use of a model to determine a property of an instrument.

### BACKGROUND

Financial institutions may trade a product or instrument (hereinafter, “instrument”). The instrument may be traded on a financial exchange. A trade may be defined by a set of contractual terms. The set of contractual terms may specify one or more properties of the instrument. For example, the instrument may be an option to purchase or sell a stock. The contractual terms associated with the option may provide a holder of the option a right to purchase or sell the stock at a price defined in the set of contractual terms. The contractual terms may allow for a right of the holder to be satisfied with a monetary payment in lieu of an actual purchase or sale of the underlying stock.

The instrument may be traded in response to detection of a pre-defined market condition. For example, an option may be traded in response to a change in a price of the underlying stock. An instrument may be traded in response to an estimation or prediction of the pre-defined market condition. The pre-defined market condition may be estimated using a model. The model may predict a future price of an underlying stock or any other suitable property of an instrument. An instrument may be traded based on a prediction of the model.

A model may be designed to predict future market conditions based on assumptions of how a property of an instrument is affected by current market conditions. The model may be associated with a restriction on how the model may be used.

For example, a model may be designed for use with specific instrument properties. A model may be designed for use with specific market conditions. Using a model to predict future market conditions based on instrument properties for which the model was not designed may lead to erroneous trades. Using a model to predict future market conditions based on current market conditions for which the model was not designed may lead to erroneous trades.

Restrictions imposed on a model on may differ across lines-of-business (“LOBs”) that utilize the model. The different restrictions may result in customized computer code developed by each LOB to verify that the restrictions placed on the model by each LOB are adhered to.

Changing a restriction may require changes to customized computer code written to implement the restriction. Changing the customized computer code may be a time-consuming process. The change process may include regression testing to ensure that the previous computer code works as previously designed when new computer code is introduced. The change process may include approvals by LOB managers before the new code may be used in a live environment.

Moreover, implementation of new restrictions that relate to properties which were previously implemented may require development of new code subject to the time-consuming process of changing the customized code.

It would be desirable to provide apparatus and methods for automated verification that a model use does not violate a restriction associated with the model. It would be desirable to provide apparatus and methods for verifying a restriction associated with the model based on a lexical item included in the restriction. It would be desirable to provide apparatus and methods for verifying a restriction associated with the model based on a lexical item corresponding to a property of an instrument.

Therefore it would be desirable to provide apparatus and methods for automated model restriction verification.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative apparatus in accordance with principles of the invention;

FIG. 2 shows an illustrative apparatus in accordance with principles of the invention;

FIG. 3 shows an illustrative arrangement in accordance with principle of the invention;

FIG. 4 shows an illustrative arrangement in accordance with principle of the invention;;

FIG. 5 shows an illustrative process in accordance with principles of the invention;

FIG. 6 shows an illustrative process in accordance with principles of the invention;

FIG. 7 shows an illustrative arrangement in accordance with principles of the invention; and

FIG. 8 shows illustrative information in accordance with principles of the invention.

### DETAILED DESCRIPTION OF THE INVENTION

Apparatus and methods for automated model restriction verification are provided.

A financial institution may trade an instrument. The instrument may be traded on a financial exchange. An instrument may include properties set forth in a contract template associated with the instrument. For example, the contract template may dictate that a holder of the instrument is entitled to a “payout” in cash or physical commodities according to the conditions in the contract template.

As a further example, an instrument may correspond to a European call option on a single stock. The contract template may include an underlying stock. The underlying stock may be a stock, quoted on a stock exchange, to which the option refers. The call option may pay out a difference between a current market price of the underlying stock and a strike price listed in the contract template.

The strike price may be an amount in an underlying currency. The contract template may state that the payout will occur in the underlying currency. The underlying currency may be the currency in which the underlying stock is quoted on the applicable stock exchange.

The contract template may include a maturity date. The maturity date may be a date and time after conclusion of the contract. A contract template may specify that a payout will occur on a maturity date if a difference between the market price of the underlying stock and the strike price is positive. The contract template may specify that if on the maturity date the difference between the market price of the underlying stock and the strike price is negative, there will be no payout.

The contract template may include an underlying price. The underlying price may be a price, quoted at the maturity date, of the underlying stock on the applicable stock exchange. The payout may be determined based on the underlying price.

A trade may include an instrument that is associated with a known value for each property of a contract template. For example, in the European call option discussed above, an exemplary trade may include the following properties and corresponding values in the contract template:
Underlying Stock=“IBM”;
Maturity Date=“Dec. 20, 2013 11 am EST”;
Underlying Currency=“USD”;
Strike Price=“190”;
Underlying Price—market price of stock on Maturity Date

A trade may only be defined for one instrument. However, an instrument may be utilized in a plurality of trades. A trading event may be an event in time at which a trade is opened (entered into trading contract), closed (exited or unwind contract from trading contract), or changed (contractual terms such as notional amounts of the trading contract are changed). The trading event may include a property such as the activity associated with the event (e.g. “open”, “close”) and a date on which the activity occurred. A trade may be associated with a plurality of trading events. For example, a trade may be opened, changed multiple times, and then closed.

A property of a trade may be a present value. The present value may be a price of a trade at a certain time. The present value may be determined by a model based on one or more other properties of the trade.

A trading platform may include an information retrieval system. The information retrieval system may electronically store a trade. The trading platform may include computer hardware and/or software. For example, the trading platform may include a code library. The code library may store a collection of computer code. The code library may retrieve trade properties for further processing.

The code library may include a function call. The function call may be a link or pointer to code stored in the code library. The function call may be invoked by a computer program. Invoking a function call may retrieve or compute a property of an instrument. For example, invoking a function call may compute a present value of a trade, or retrieve a maturity date of a trade. The function call may return the property to the computer program that invoked the function call.

A function call may be written for an instrument. A function call may be executed for a trade. The function call may compute a property of the trade based on other known properties of the trade.

A model may include a mathematical algorithm which computes a property of an instrument. A model may be implemented by a piece of code stored in the code library. The code corresponding to the model may be invoked using a function call.

A model may compute a property of an instrument based on assumptions about another trade property. The model may compute a property of an instrument based on assumptions about yet unknown instrument properties. The model may compute an approximate future value for a currently known property of an instrument.

A property of an instrument may not be included in a contract template of the instrument. The property may be determined by a model. The property may be determined based on a property included in the contract template. An exemplary instrument property that may be determined by a model may include a present value of the instrument. The present value may be determined with respect to changes in financial market variables. An exemplary instrument property determined by a model may include a sensitivity of a property of the instrument determined with respect to a value of one or more financial market variables.

Associating a model with an instrument may form a model-instrument pair. For example, a model-instrument pair may be a Black-Scholes option pricing model applied to a European call on a single stock.

A business may choose an instrument as a template for a trade. The business may associate a restriction with the trade. The restriction may be expressed as a function of a property of the instrument.

A line-of-business (“LOB”) may determine an appropriate model to determine or compute a property of an instrument. The selected model and instrument may form a model-instrument pair. The LOB may generate computer code to adapt an existing model for use with the instrument template. The LOB may generate computer code to create a new model for use with the instrument template. The LOB may add or change restrictions associated with a model-instrument pair.

The model-instrument pair may be validated. Validation of the model-instrument pair may confirm or change restrictions and/or impose new restrictions. After validation, control functions, such as risk managers, may add or change restrictions before approving a model-instrument pair or processing trades based on the model-instrument pair. After all validation procedures have been exhausted, a model-instrument pair is approved for trading on the trading platform. Once a model-instrument pair is approved for trading, restrictions associated with the model-instrument pair are final.

Restrictions implemented in a code library may be periodically executed on the trading platform to verify that the restrictions are not violated.

A model-instrument pair may be associated with a restriction. An exemplary restriction may limit an output of a model to a specific property of an instrument. A restriction may limit an input of a model to a specific property of an instrument included. For example, an exemplary restriction may include a Black-Scholes option pricing model (the model) for use with European call options (the instrument) having underlying stocks listed in the S&P500 and a maturity date no longer than 2 years at a time of a trade (the restrictions).

A restriction associated with a model-instrument pair may be identified by a rule name. The rule name may include text describing the restriction. The rule name may be associated with a rule formula. For example, the rule name and the rule formula may be stored in different columns of a row in a rules table. Each row in the rules table may correspond to a different restriction. The rule formula may be a mathematical formula.

The rule formula may include a mathematical expression. Parsing the mathematical expression may yield computer code for implementing the restriction. The computer code may be a function call. The function call may be stored in a code library. Evaluating the rule formula may determine compliance with the restriction.

For example, a mathematical expression may include to: “$TimeToMaturity<=5.0.” For a given instrument i₁, the exemplary mathematical expression may be parsed to become a function call corresponding to:

dateDiffInYears(datetime.time.today( ) i1.MaturityDate( ))<=5.0

Computer code invoked by the function call may determine whether given the maturity date of instrument i₁, time remaining until the maturity date of instrument i₁ is less than five years. A model or trade may be restricted to an instrument that has less than five years remaining until the maturity date of the instrument.

A row in a rules table may include a violation text column. The violation text may be displayed when code generated by a rules formula evaluates to false or triggers an exception. A rules formula that evaluates to false or triggers the exception may indicate that a property of the instrument does not comply with the restriction.

A row in a rules table may include a column for storing additional information. The additional information may be displayed when code generated by a rules formula evaluates to false or triggers an exception. The additional information may be displayed by the trading platform. The additional information may include a lexical item. The additional information column may link the restriction to a lexical item.

An instrument property may be identified based on a lexical item. A lexical item may include a text string corresponding to an instrument property. A lexical item may be formatted in a fashion that allows for parsing of the text string and human recognition. For example, a lexical item may begin with a special character, e.g. a “$.”

In some embodiments, a lexical item may not include white spaces. A lexical item may be stored in a lexical item table. Each row in the lexical item table may correspond to an instrument property. The lexical item table may include columns. Each column may correspond to information linked to instrument property. For example, a lexical item table may include the following illustrative columns for a specific instrument property (row in the lexical item table): a function call, a condition, a description, a sample and a type.

The function call column may include an instruction for invoking a function call. A function call may be preceded by a reserved string. The reserved string may indicate that whether the function call operates on an instrument, trade, trading event or model. In some embodiments, a function call may not be preceded by a reserved string.

For example, a function call may retrieve or compute a property of an instrument. An instruction for invoking a function call that acts on an instrument may include a reserved string “_i.”

As a further example, a function call may retrieve or compute a property of a trade. An instruction for invoking a function call that acts on a trade may include a reserved string “_t.”

As a further example, a function all may retrieve or compute a property of a trading event. An instruction for invoking a function call that acts on a trading event may include a reserved string “_e.”

A function calls may be invoked unconditionally or conditionally. The condition column may indicate whether a function call is associated with a condition. The condition column may be empty. If the field in the condition column is empty, the function call is invoked unconditionally. The condition column may include an integer value. The integer value may indicate that a function calls has been assigned a rank. Function calls that are assigned a rank are invoked one after another, in order of rank until no exception is thrown.

For example, a first row in a lexical item table may include a first function call and a “1” in the condition column. The first function call is invoked before any other function calls in the lexical items table. If no exception is triggered by invoking the first function call, a value returned by the first function call is accepted by the computer program that invoked the first function call. The value returned by the first function call may be a Boolean value. After invoking the first function call, a second function call associated with a “2” in the condition column may be invoked.

The description column may include text describing the lexical item. The description column may describe the property expected to be returned by the function call. The sample column may include a sample value of the property expected to be returned by an invoked function call. Information included in the sample column may be used for performing a semantic check to ensure that the computer code is executing properly. For example, the function call may be substituted in to a rules formula to confirm that an output of the rules formula indicates compliance with the restriction corresponding to the rule formula.

The type column may include a variable type that describes a value expected to be returned by the invoked function call. A value returned by an invoked function call may be compared to the variable type to verify that the returned value is of the type indicated in the type column.

A restriction may be defined for a property of an instrument before the property is assigned a value. The restriction may be defined using a placeholder for the value. The restriction may be verified for a trade because a trade is based on a value assigned to the instrument property.

A financial institution may operate multiple lines of business (“LOBs”). Each LOB may execute a plurality of trades. Each trade may be different. Each LOB may execute trades that involve an identical instrument. Each LOB may execute trades that involve different instruments. For each trade, a model may approximate a property of the instrument underlying the trade. The model and the instrument may form a model-instrument pair. A restriction may be imposed on the model-instrument pair.

Embodiments may include a function call that may be invoked by the plurality of LOBs. For each trade, trading event, instrument and/or model-instrument pair, the function call may identify an entry in a rules table containing the impose restriction. The restriction may be expressed as a lexical item. The lexical item may be standardized for each of the LOBs.

The function call may read information stored in a lexical items table. The information stored in the lexical items table may translate the lexical item into computer code. The computer code embodying the restriction and corresponding to the lexical item may be executed to verify that the restriction as imposed on the trade, instrument, trading event and/or model-instrument pair is complied with.

In response to an evaluation of a restriction, an exception report may be generated. The exception report may be generated for a restriction imposed on one or more trades, trading events and/or model-instrument pairs. Specifically, an exception report may be generated once, or continuously to view compliance with restrictions on trading events as the trading events occur. An exemplary Exception Report may include: Date and type of a trading event, identification number of a trade, rule name, violation text and/or additional information relating to the restriction violated.

Apparatus and methods according to principles of the invention may perform automated restriction verification. Apparatus and methods may include computer code. The computer code may be configured to generate additional computer code. Apparatus and methods may operate on trades, trading events instruments and/or model-instrument pairs. Each trading event may be associated with a trade. Each trade may be based on an instrument that is associated with concrete properties. Based on a known value of a property, a restriction may be evaluated without ambiguity. For a trading event the trade, the instrument and associated properties are unambiguously defined.

Apparatus and methods according to the invention may facilitate verification of a restriction by creating a new entry for a property of an instrument in a lexical item table. No new computer code must be written or tested for adding or changing restrictions. Function calls that differ across LOBs may be entered once into a lexical item table and be utilized for each of the plurality of LOBs.

Changes of restrictions may be accomplished by changing the rules table. Any users (e.g. validators, risk managers) do not need to know how the Rules are translated into code. A function call will translate the restrictions into code based on lexical items associated with the restriction.

Restrictions relating to trade properties may be linked to a lexical item via a rules table. New rules or restrictions may be added to the rules table by creating a new entry in the rules table. A new entry in the rules table may include lexical items that already exist in the lexical items table. The new entry in the rules table may include lexical items that do not exist in the lexical items table. A new entry may be created in the lexical items table that corresponds to lexical items associated with the new rule.

Automated checks may be deployed to ensure that function calls utilized to implement automated verification of a restriction do not generate faulty code. For example, computer program code may check a lexical item table to verify that a variable “type” is valid for the property corresponding to the lexical item. The computer code may check the lexical item table to determine if a sample entry in the lexical item table has a variable type corresponding to the valid variable type.

The computer code may check the lexical item table to verify that a function call stored in the table is defined in the given code context associated with the lexical item. The computer code may check the lexical item table to that a function calls listed in the table returns a value of the valid variable type.

The computer code may check a rules table to verify that a formula stored in the rules table includes one or more lexical items that exist in the lexical items table. The computer code may check a rules table to verify that any additional information listed in the rules table contains one or more lexical items that exist in the lexical items table.

The computer code may substitute a sample value for one or more lexical items and execute one or more function calls to verify that a valid response is produced (i.e., a Boolean value is produced).

An automated check may be performed in response to a change to a lexical item or rules table. If a change is made to the lexical items table, the checks may be run for the rules table even if no change has been made to the rules table.

The automated checks may be performed in any suitable order or sequence. The automated checks may be performed conditionally based on a result of a previously executed check.

Apparatus and methods for automated restriction verification are provided. Apparatus may include a trading system. The trading system may be configured to execute a trade. The trading system may be an electronic trading platform. The trading system may include a non-transitory computer-readable medium storing computer-executable instructions. When the instructions are executed by a processor on a computer system, the apparatus may perform a method for validating a trade and/or a restriction associated with the trade. The computer-executable instructions may correspond to a function call. The computer-executable instructions may be stored in a code library. The code library may be accessed by the trading system.

The computer-executable instructions may be configured to cause the computer system to receive a request to trade an instrument. The instrument may include a set of contractual terms. The trade may be based on the set of contractual terms. The set of contractual terms may include members. The members may be properties of the instrument and/or trade. Illustrative members of the set may include: an underlying asset, a maturity date and an underlying currency. The instrument may include a “payoff” defined by one or more members of the set of contractual terms.

The trade may be based on an output of a model applied to the instrument. The model may compute or predict a property of the instrument. Applying the model to the instrument may form a model-instrument pair.

The instrument may be associated with a restriction. The model may be associated with a restriction. The trade may be associated with a restriction. The model-instrument pair may be associated with a restriction. The computer-executable instructions, when executed by the processor, may identify a lexical item associated with the restriction.

The trading system may identify a lexical item associated with a restriction. The lexical item corresponding to the restriction may be identified by reading a rules table. The rules table may be stored in a non-transitory computer readable media. The trading system may identify a formula associated with the restriction by reading the rules table. Each row in the rules table may correspond to a restriction. Each row or restriction may be applied to one or more trades, instruments and/or model-instrument pairs. Each row may include one or more columns. The one or more columns may include information linked to the restriction corresponding to the row.

A lexical item may be one of a plurality of lexical items. Each of the plurality of lexical items may be stored in the lexical table. A rules table may include a plurality of restrictions. Each row in the rules table may correspond to one of the plurality of restrictions. Each row in the rules table may link a restriction to at least one of the plurality of lexical items.

The lexical item may be a template for a property of an instrument or model-instrument pair. Exemplary lexical items may correspond to properties such as a payoff currency range, a time to maturation range and/or an interest rate range.

The lexical item may correspond to a property that is not yet known at a time the lexical item is entered into a lexical items table. The lexical item may correspond to a property that is not yet known at a time the lexical item is linked to a restriction. For a trade, a function call may retrieve the property corresponding to the lexical item after the property is assigned a value.

The lexical item may be identified based on an entry in a rules table. The rules table may include a plurality of rows. Each row in the rules table may correspond to a restriction. Each row in the rules table may include a plurality of columns. An entry in a column of a row in the rules table may link the restriction to the lexical item.

The computer-executable instructions when executed by the processor may determine a member of the set of contractual terms corresponding to the lexical item. The computer executable instructions may include a function call that determines a value of a property of the instrument corresponding to the lexical item. The value may be a member of the set of the set of contract terms of the instrument. The value may be a numerical value, an alphanumeric string of characters or any suitable value. The property may be a property determined by a model applied to the instrument.

The computer-executable instructions, when executed by the processor, may determine compliance of the trade with a restriction. The computer-executable instructions may generate a formula corresponding to the restriction. The formula may be generated based on a formula template. The formula template may be stored in a row of a rules table.

The rules table may link a formula template of the formula to a restriction. The formula template may include a lexical item. A function call may replace the lexical item in the formula template with a value of a property of the instrument.

The generated formula may be evaluated based on a value of a property of a trade. For example, the formula may be evaluated based on a value of a condition in a contract template of an instrument underlying the trade.

The formula may include an operator. The operator may instruct a computer system to compare a value corresponding to a lexical item to a reference condition. The reference condition may include one or more value. The value may be compared to the one or more values. Illustrative operators include >, <, +, −, *, /, MOD, log, exp, NOT, AND, OR, ==, !=, and IN. The operator may be a mathematical operator, a Boolean operator, a logical operator, a set operator or any suitable operator.

Based on an evaluation the formula, the computer system may determine whether the trade is in compliance with the restriction. For example, evaluation of the formula may return a Boolean value. The Boolean value returned may be “true.” The Boolean value may be “true” if a condition defined by the operator is true for the value corresponding to the lexical item. The trading system may be configured to execute the trade when the evaluating of the formula returns a Boolean value corresponding to “true.” The trading system may be configured to confirm compliance of the trade with the restriction when the evaluating of the formula returns a Boolean value corresponding to “true.”

The Boolean value returned may be “false.” The Boolean value may be “false” if a condition defined by the operator is not satisfied for the value corresponding to the lexical item. The trading system may be configured to flag the trade when the evaluating of the formula returns a Boolean value corresponding to “false.” The trading system may be configured to identify a trade that violates a restriction when the evaluating of the formula returns a Boolean value corresponding to “false.”

The trading system may include computer-executable instructions when executed by the processor receive a change to the formula. In response to receiving the change, the trading system may evaluate the formula based on the change. The change may correspond to a change in a restriction. The change may be imposed on a trade, instrument and/or model-instrument pair that is linked to the restriction. A trade, instrument and/or model-instrument pair may be linked to a restriction based on a selection of the instrument/model as a basis for a trade.

An exemplary formula template may be expressed as:

$PayoffCcy IN [“CHF”, “EUR”, “GBP”, “JPY”, “USD”]

The formula template includes a lexical item “$PayoffCcy.” The lexical item “$PayoffCcy” may represent a payoff currency of an instrument. A lexical item table may link the term $PayoffCcy to a function call. The function call may obtain a value of the payoff currency of the instrument. The value of the payoff currency may be an identifier of the currency in which a payoff of the instrument occurs.

The formula template may include a set of valid payoff currencies. The value corresponding to the payoff currency of the instrument may be compared to each member of a set of valid payoff currencies. If the value retrieved by a function call corresponds to at least one member of the set of currencies, the restriction represented by the formula template is satisfied.

In the exemplary formula above, the restriction imposed on the instrument requires that the payoff currency be in Swiss francs (“CHF”), Euros (“EUR”), British pounds (“GBP”), Japanese yen (“JPY”) or U.S. dollars (“USD”).

A change to the formula may correspond to an addition of a member to a set of entries associated with the formula. For example, the exemplary payoff currency template may be changed to add Canadian dollars (“CAD”) to the list of acceptable payoff currencies. After implementing the change, an instrument that includes a payoff currency in CAN may satisfy the restriction embodied by the exemplary formula template.

A change to the formula may correspond to a deletion of a member from a set of reference values associated with the formula. For example, in the exemplary payoff currency template, “CHF” may be deleted from the set of valid payoff currencies. After the deletion of CHF, an instrument or trade that includes a payoff currency in Swiss francs will not satisfy the restriction embodied by the exemplary formula template.

The trading system may include a lexical item table linking a lexical item to a function call. The function call, when executed by a processor on a computer system, may determine a member of a set of contractual terms corresponding to the lexical item. For example, for a given instrument, invoking a function call linked to a lexical item may return the value corresponding to a maturity date of the instrument.

Apparatus may include a trading system configured to receive, from a line-of-business (“LOB”), a request to trade an instrument. The LOB may be operated by a financial entity such as a bank. The request may include a first property of the instrument. The first property of the instrument may be determined by a model applied to the instrument. The instrument and the model may form a model-instrument pair.

In response to receiving the request, the trading system may be configured to execute a function call. The function call may be a first function call. The first function call may be configured to identify a restriction on using the model to determine the first property of the instrument. The first function call may identify a lexical item associated with the restriction. The lexical item may be linked to the restriction in a rules table.

The first function call may invoke another function call. For example, the first function call may invoke a second function call. The first function call may identify the second function call based on the lexical item associated with the restriction.

The trading system may execute the second function call. The second function call may determine a second property of the instrument. The second property may be different from the first property. The second property of the instrument may be a value. The second property of the instrument may be a value. The second property of the instrument may be a member of the set of contractual terms of the instrument. The second property of the instrument may be a lexical item associated with the restriction identified by the first function call.

The second function call may be configured to transfer the second property to a third function call. The trading system may execute the third function call. The third function call may be executed using the second property as an input.

The third function call may be configured to identify a formula corresponding to the restriction. The formula may be stored in a rules table. The third function call may evaluate the formula based on the second property of the instrument. The third function call may determine a compliance of the trade request with the restriction based on an output of evaluating the formula.

A lexical item may be one of a plurality of lexical items. Each of the plurality of lexical items may be stored in a lexical items table. For each of the plurality of lexical items, the second function call may be configured to identify a second property corresponding to each of the plurality of lexical items.

For each of the plurality of lexical items, the third function call may be configured to identify a formula linked to each lexical item. The third function call may be further configured to evaluate each formula linked to each to each lexical item. The third function call may evaluate each formula based on the second property corresponding to the lexical item linked to the formula. Evaluating the formula may determine if a restriction imposed on a trade has been satisfied.

The lexical items table may include a column that stores a conditional rank. The conditional rank may correspond to an order in which the second function call is configured to identify the second property for each of a plurality of lexical items. The conditional rank may determine an order in which the second function call passes a plurality of second properties to the third function call.

The trading system may include a rules table. The rules table may link a restriction to a formula. The rules table may link a lexical item to a restriction. For example, a rules table may include a plurality of rows. Each row may correspond to a restriction. Each row may include a plurality of columns. A first column may identify a rule name that identifies the restriction. A second column may link the formula or formula template to the restriction. A third column may link a violation text to the restriction. The violation text may be displayed if the second property does not satisfy the restriction corresponding to the formula. A fourth column in the rules table may identify the lexical item linked to the restriction.

The trading system may be configured to adjust the restriction by changing the formula linked to the lexical item. The formula may be changed by changing a reference value within the formula. The formula may be changed by adding or deleting a reference value.

A trade request may be a first trade request. An instrument may be a first instrument. A model may be a first model. The trading system may be configured to receive a second request. The second trade request may include a request to trade a second instrument. The second request may include a first property of the second instrument determined by a second model. The trading system may be configured to execute a first function call. The first function call invoked in response to receiving the second trade request may be the first function call invoked in response to receiving the first trade request.

The first function call may be configured to identify, in response to receiving the second trade request, a lexical item in the second trade request. The lexical item in the second trade request may be the lexical item identified in the first trade request.

The first function call may be configured to identify a second function call corresponding to the lexical item in the second trade request. The trading system may be configured to execute the second function call. The second function call may be the second function call invoked in response to receiving the first trade request.

The second function call may be configured to determine a second property of the second instrument. The second property of the second instrument may correspond to the lexical item identified in the second trade request. The second property of the second instrument may be a value associated with the second instrument. The second property of the second instrument may be different from the second property of the first instrument.

The second function call may pass the second property of the second instrument to a third function call. The third function call may be the third function call invoked in response to receiving the first trade request.

The trading system may be configured to execute the third function call. The third function call may be configured to identify a formula linked to the lexical item identified in the second trade request. The formula may correspond to a restriction on using a model to determine the first property of the second instrument. The formula may be the formula evaluated in response to receiving the first trade request.

The trading system may evaluate the formula based on the second property of the second instrument. The trading system may determine a compliance of the second trade request with the restriction based on an output of the formula.

The trading system may be configured to receive an adjusted trade request from a LOB. In response to receiving the adjusted trade request, the trading system may add at least one row to the lexical items table. In response to receiving the adjusted trade request, the trading system may delete at least one row from the lexical items table. The deletion may correspond to a change in a restriction or instrument

Apparatus may include an electronic trading platform. The platform may be configured to store an instrument. The platform may be configured to store a restriction associated with the instrument.

In response to a receiving a trade based on the instrument, the platform may be configured to identify, in a lexical items table, at least one lexical item associated with the restriction. The platform may be configured to obtain a property of the trade. The property of the trade may correspond to the at least one lexical item associated with the restriction.

Using the property of the trade as an input, the platform may compute an output of a formula. The formula may correspond to the restriction. The output of the formula may correspond to verifying that the trade complies with the restriction. Based on the output of the formula, the platform may determine if the trade violates the restriction.

The property of a trade may correspond to a property of the instrument. The property of a trade may correspond to an activity associated with the trading event. The activity associated with a trading event may include “opening” and/or “closing” a trade. The trading event may include a date on which the activity happened. A trade may be associated with a plurality of trading events. For example, a trade may be opened, changed multiple times, and then closed.

A lexical item may be a first lexical item associated with the trade. The electronic trading platform may be configured to identify a second lexical item associated with the trade. Based on the second lexical item, the platform may obtain a second property of the trade corresponding to the second lexical item. The platform may formulate a second trading restriction associated with the trade based on the second property corresponding to the second lexical item. The second trading restriction may include a second formula.

The platform may compute an output of the second trading restriction. Based on the output of the second trading restriction, the platform may determine if the trade violates the second trading restriction.

The trading platform may be configured to process trades for a plurality of LOBs. Each of the LOBs may be operated by an entity. The LOBs may share a lexical items table.

The electronic trading platform may be configured to receive an update to a trading restriction associated with a trade. In response to receiving the update, the platform may be configured to adjust a rule corresponding to the trading restriction. The rule corresponding to the trading restriction may be expressed as a formula. The platform may compute the output of the trading restriction based on the adjusted rule. Based on the output, the platform may determine if the trade violates the adjusted rule.

The trading system may be configured to perform a check to reduce a risk that a function call may generate erroneous computer code.

For example, the trading system may verify that a lexical item stored in the lexical item table is associated with a valid variable type. A valid variable type may correspond to a property represented by the lexical item. The variable type may define a value of the property expected to be returned by the function call.

The trading system may examine a sample entry associated with a lexical item. The trading system may determine whether the sample entry corresponds to the valid variable type.

As a further example, a lexical item stored in a lexical item table may be linked to a function call. The function call may be configured to determine a property corresponding to the lexical item. The trading system may determine if the function call linked to the lexical item is defined within a given code context. The trading system may determine whether the function call returns a variable type identical to the variable type associated with the lexical item that is linked to the function call.

The trading system may include a rules table. The rules table may include a plurality of rules. Each rule may correspond to a restriction. The trading system may determine whether for each rule stored in the rules table a lexical item used in a rule formulation is stored in the lexical item table. A rule that includes a lexical item that is not stored in the lexical item table may prevent verification of the rule.

For each rule stored in the rules table, the trading system may evaluate a trading restriction corresponding to the rule using a sample entry stored in the lexical item table. Based on the evaluating the rule using the sample entry, the trading system may determine whether the output of the trading restriction is an expected value. For example, based on the evaluating the rule using the sample entry, the trading system may determine whether the output of the trading restriction is a Boolean value.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Illustrative embodiments of apparatus and methods in accordance with the principles of the invention will now be described with reference to the accompanying drawings, which form a part hereof. It is to be understood that other embodiments may be utilized and that structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

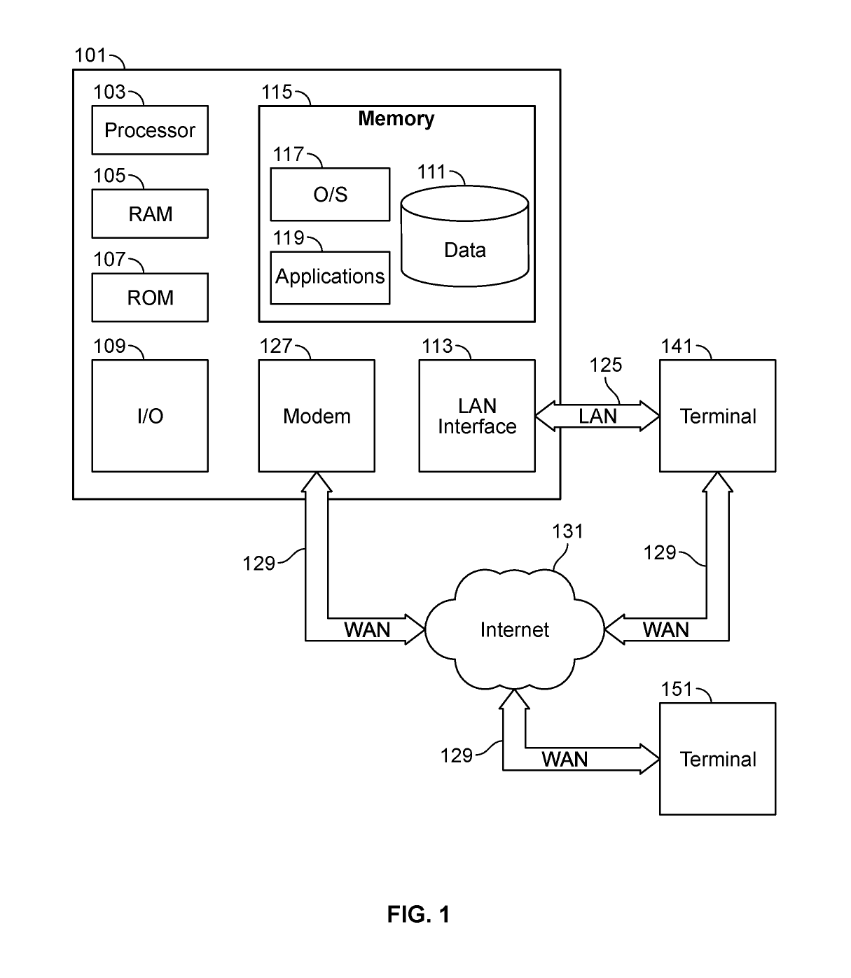

FIG. 1 is a block diagram that illustrates a computing device 101 (alternatively referred to herein as a “server or computer”) that may be used according to an illustrative embodiment of the invention. The computer server 101 may have a processor 103 for controlling overall operation of the server and its associated components, including RAM 105, ROM 107, input/output (“I/O”) module 109, and memory 115.

I/O module 109 may include a microphone, keypad, touch screen and/or stylus through which a user of device 101 may provide input, and may also include one or more of a speaker for providing audio output and a video display device for providing textual, audiovisual and/or graphical output. Software may be stored within memory 115 and/or other storage (not shown) to provide instructions to processor 103 for enabling server 101 to perform various functions. For example, memory 115 may store software used by server 101, such as an operating system 117, application programs 119, and an associated database 111. Alternatively, some or all of computer executable instructions of server 101 may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown). Terminal 151 and/or terminal 141 may be portable devices such as a laptop, tablet, smartphone or any other suitable device for receiving, storing, transmitting and/or displaying relevant information.

Any information described above in connection with database 111, and any other suitable information, may be stored in memory 115. One or more of applications 119 may include one or more algorithms that may be used to receive model information, receive values, evaluate formulas, determine compliance of a trade with a restriction, read lexical item tables, read rules tables and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

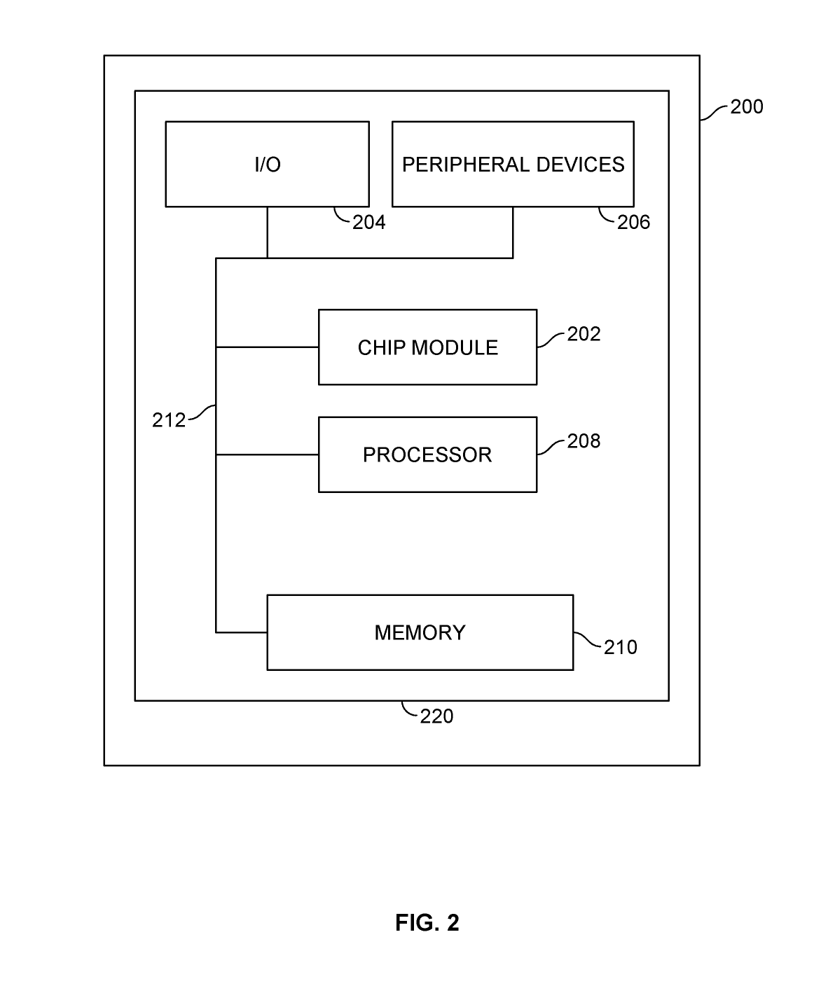

FIG. 2 shows an illustrative apparatus that may be configured in accordance with the principles of the invention.

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may compute data structural information, structural parameters of the data, quantify indices; and machine-readable memory 210.

Machine-readable memory 210 may be configured to store in machine-readable data structures: exception reports, rules tables, lexical items tables, computer code and any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

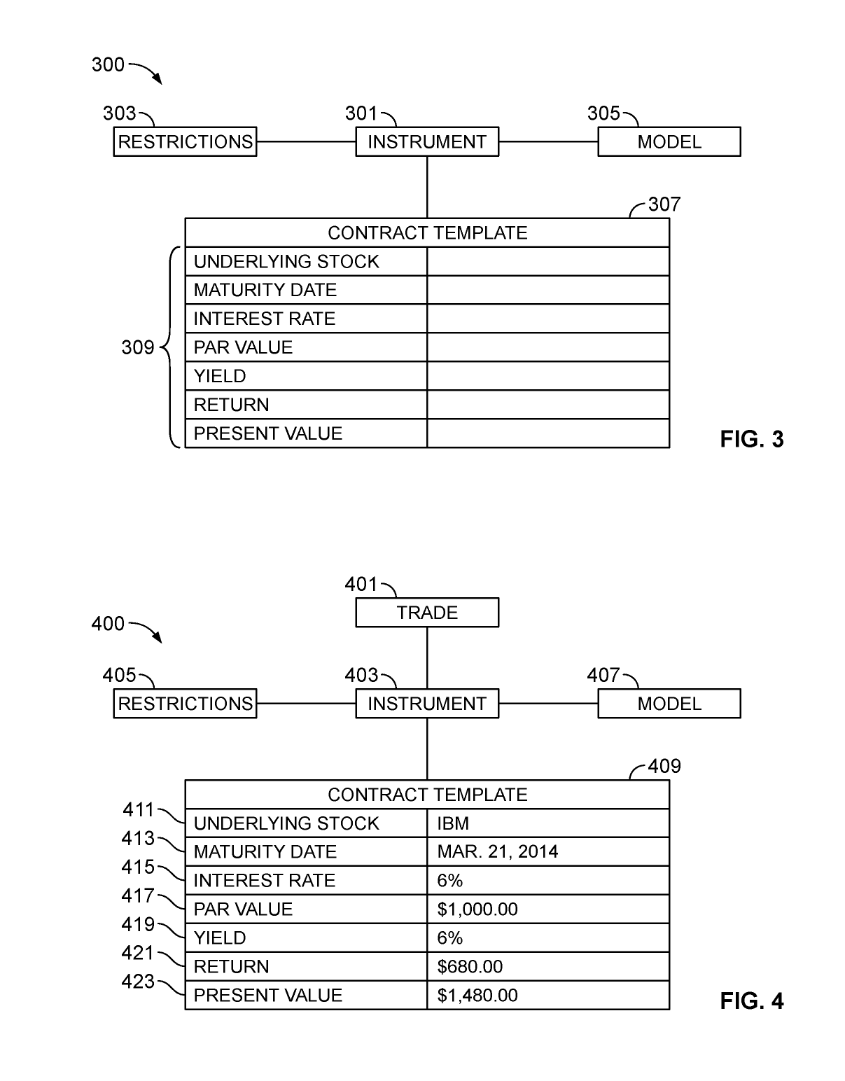

FIG. 3 shows illustrative arrangement 300. Arrangement 300 includes instrument 301. Instrument 301 is linked to contract template 307. Contract template 307 includes illustrative set of contractual terms 309. Terms 309 have not yet been associated with values.

Instrument 301 is linked to model 305. Model 305 may determine a value of at least one of terms 309. Instrument 301 is linked to restrictions 303. Restrictions 303 may be imposed as a result of an associated between model 305 and instrument 301. Restrictions 303 may limit a use of model 305 to determine a value of terms 309 for instrument 301.

FIG. 4 shows illustrative arrangement 400. Arrangement 400 includes trade 401. Trade 401 is based on instrument 403. Instrument 403 is linked to model 407. Instrument 403 is linked to restrictions 405. Instrument 403 includes contract template 409. Contract template 409 is associated with terms 411-423. Each of terms 411-423 is associated with a value. For example, term 411 indicates that the stock underlying trade 401 is “IBM.”

One or more values for terms 411-423 may be determined by applying model 407 to instrument 403. For example, for trade 401, term 419 indicates that a yield of trade 401 is estimated to be 6%. Term 419 may be estimated by model 407. As further example term 423 indicates that a present value of trade 401 is $1,480.00. Term 423 may be determined by model 407.

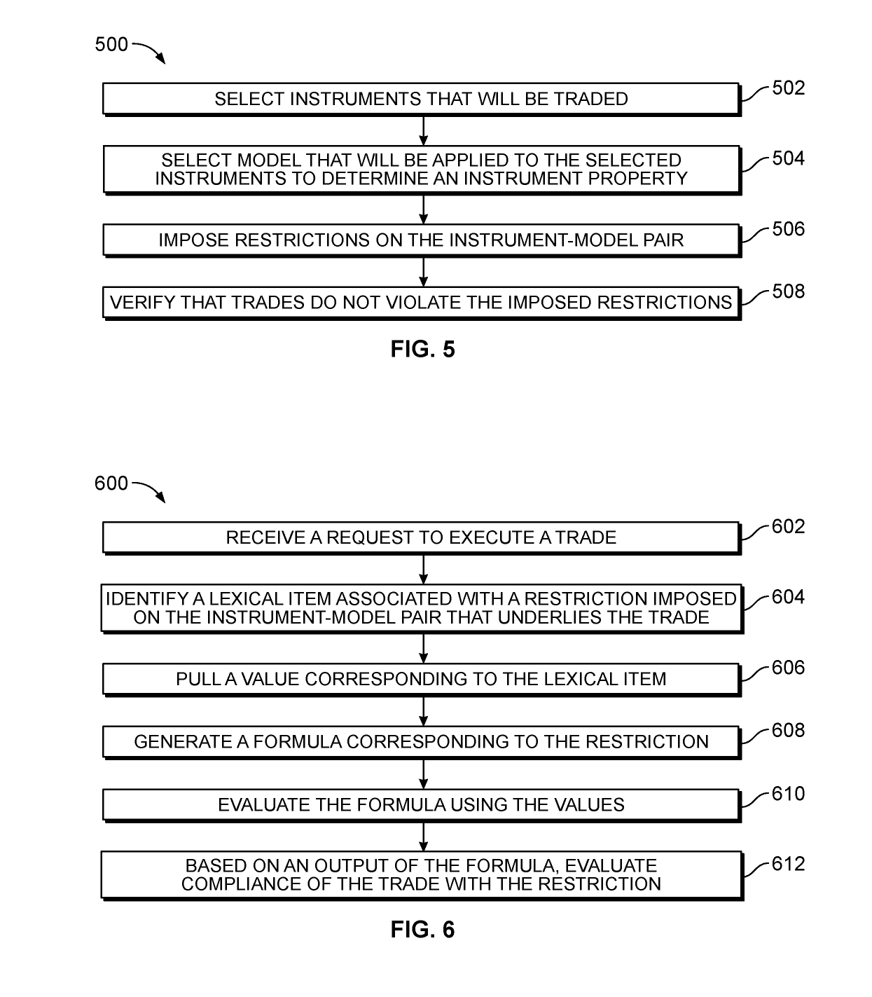

FIG. 5 shows illustrative process 500. For the sake of illustration, one or more of the steps of the process illustrated in FIG. 5 will be described as being performed by a “system.” The “system” may include one or more of the features of the apparatus, arrangements information or processes shown in FIGS. 1-4 and/or any other suitable device or approach. The “system” may be provided by an entity. The entity may be an individual, an organization or any other suitable entity.

Process 500 begins at step 502. At step 502, the system selects instruments that will be traded. The instruments may be traded using an electronic trading platform. At step 504, the system selects a model that will be applied to the selected instrument. The model may be used to determine a property of the selected instrument. The property of the instrument may be a member of a set of contractual terms associated with the instrument. The association between model and the instrument may form a model-instrument pair.

At step 506, the system imposes restrictions on the model-instrument pair. The restrictions may limit use of the model. For example, the restrictions may only allow the model to calculate a property of the instrument if one or more other properties of the instrument are within a specified range or set of values.

At step 508, the system verifies that a trade executed on the trading platform does not violate the restrictions imposed on the trade. The restrictions may be verified before a trade is executed. The restrictions may be verified after a trade is executed. A trade may be randomly selected for restriction verification.

FIG. 6 shows illustrative process 600. For the sake of illustration, one or more of the steps of the process illustrated in FIG. 6 will be described as being performed by a “system.” The “system” may include one or more of the features of the apparatus, arrangements information or processes shown in FIGS. 1-5 and/or any other suitable device or approach. The “system” may be provided by an entity. The entity may be an individual, an organization or any other suitable entity.

At step 602, the system receives a request to execute a trade. The trade may include a model-instrument pair. The system may include an electronic trading platform. At step 604, the system identifies a lexical item associated with a restriction imposed on the model-instrument pair. The trade may be based on the model-instrument pair. At step 606, the system determines a value corresponding to the lexical item. The value may be determined by invoking a function call. The value may be stored in a contract template linked to the instrument or model-instrument pair.

At step 608, the system generates a formula corresponding to the restriction. The formula may include an operator that compares the value to a reference value. The formula may be expressed using a lexical item. At step 610, the system evaluates the formula using the values corresponding to the lexical item used to express the formula. At step 612, the system, based on an output of the formula, evaluates compliance of the trade with the restriction.

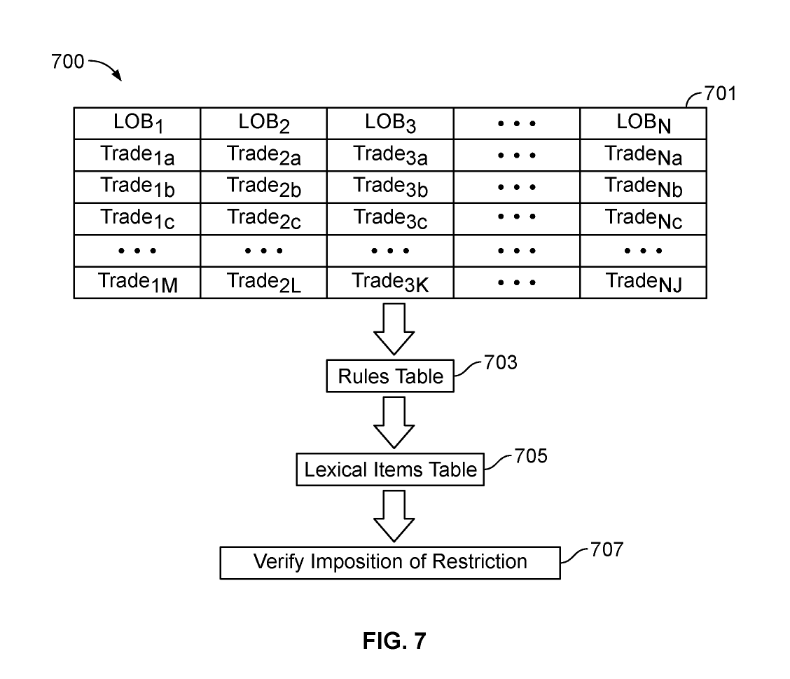

FIG. 7 shows illustrative arrangement 700. Arrangement 700 shows a plurality of lines-of-business LOB₁-LOB_{N}. Each LOB may submit a plurality of trades to a trading platform. For example, LOB₁ may submit trade₁ₐ-trade_{1M}.

For each trade submitted by LOB₁-LOB_{N}, a restriction may be identified. A restriction may be stored in rules table 703. Each of LOB₁-LOB_{N} may utilize rules table 703 to identify a restriction associated with a trade submitted by the LOB. Each restriction in rules table 703 may be defined by one or more lexical items.

Each lexical item associated with a restriction may correspond to an entry in lexical items table 705. Lexical items table 705 may identify a function call corresponding to the lexical item. The function call may be configured to obtain a value corresponding to a lexical item. The value may be obtained from a contract template linked to the trade. The value may be a property of the trade and/or instrument.

Each of LOB₁-LOB_{N} may utilize lexical items table 705 to identify a function call corresponding to a restriction imposed on a trade.

A value returned by the function call may be used to evaluate a formula corresponding to the restriction associated with the trade. The formula may be expressed using one or more lexical items. The formula may be evaluated. The formula may be evaluated using the value corresponding to the lexical item.

At step 707, based on the evaluating of the formula, the system may verify whether the trade complies with the restriction.

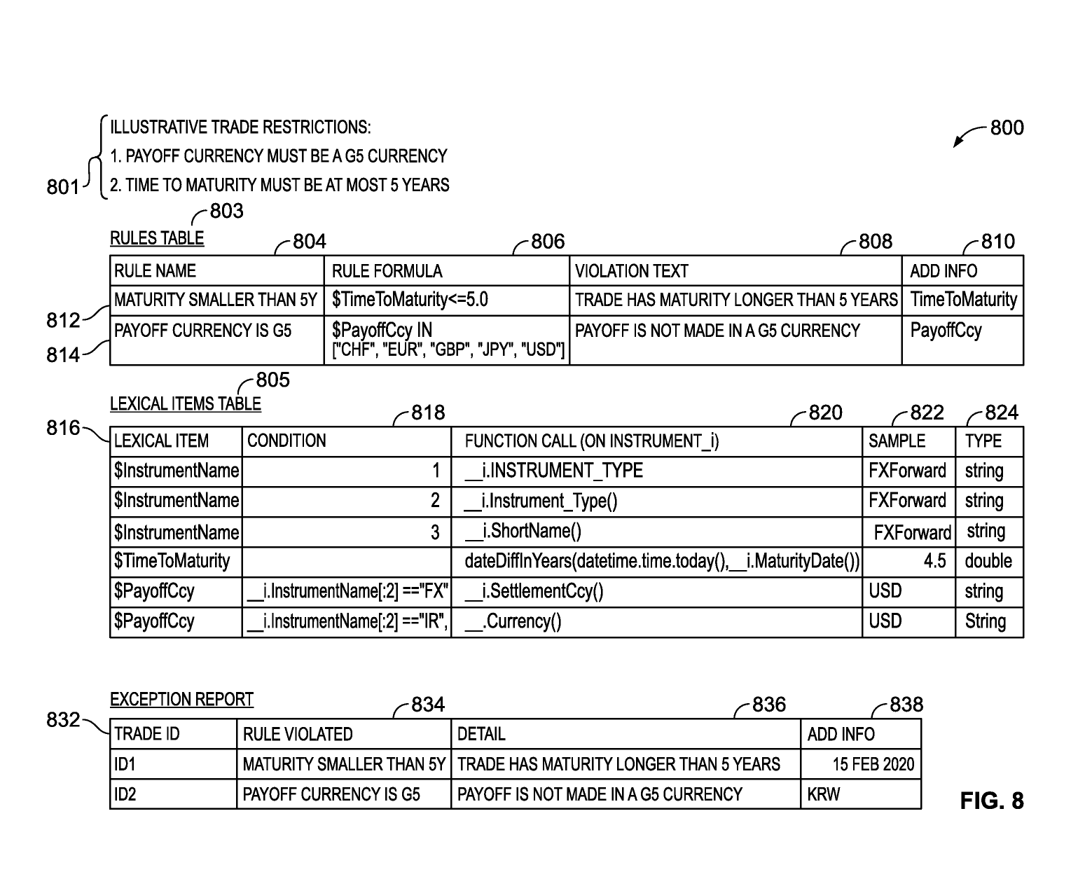

FIG. 8 shows illustrative information 800. Information 800 includes illustrative restrictions 801. Illustrative restrictions 801 may be verified using rules table 803 and lexical items table 805. Exception report 807 may display a result of the verifying of the restriction.

Rules table 803 may include rule name column 804. Rule name column 804 includes a name of a restriction. For example, rule name column 804 includes name 812 “maturity smaller than 5Y.” As a further example, rule name column 804 includes name 814 “payoff currency is G5.”

Rules table includes formula column 806. Formula column 806 includes a formula. The formula may correspond to a restriction. The formula may be expressed using one or more lexical items. For example, a rule formula corresponding to the restriction titled “payoff currency is G5” includes lexical item “$PayoffCcy.”

The formula includes logical operator “IN.” The formula includes reference values “CHF,” “EUR,” “GBP,” “JPY” and “USD.” Each of the five reference values included in the formula correspond to one of the G5 currencies.

Rules table 803 includes violation text column 808. Violation text column 808 may be displayed if a value corresponding to the lexical item does not satisfy a formula. Rules table 803 includes additional information column 810. Additional information column 810 identifies the lexical item used in the formula in formula column 806.

The lexical item included in formula column 806 and/or additional information column 810 may be used as a cross-reference to locate an entry in lexical items table 805. Lexical items table 805 includes lexical items column 816. Lexical items table 805 includes conditions column 818. Lexical items table 805 includes function call column 820.

For each lexical item identified in rules table 803, a corresponding lexical item may be identified in lexical item column 816. If lexical item column 816 includes multiple entries of a lexical item, a row in lexical item table 805 may be selected based on evaluated a condition stored in condition column 818. After selecting a row in lexical item table 805, a function call stored in function call column 820 may be invoked.

For example, for a lexical item corresponding to “$InstrumentName,” one of three function calls may be invoked according to whether the trade satisfies one or more of the conditions listed in conditions column 818.

Lexical items table 805 includes sample column 822. Sample column 822 includes an exemplary value that is expected to be returned by a function call listed in function call column 820.

Lexical items table 805 includes type column 824. Type column 824 includes a classification type of the value expected to be returned by a function call listed function call column 820.

The value returned by a function call may be inserted into a formula listed in the place of a lexical item. A formula may be evaluated based on the value returned by the function calls.

After a formula has been evaluated for a trade, an output of the evaluating may be organized in exception report 807. Exception report 807 includes trade ID column 832. Trade ID column 832 may list an identifier of a trade that has not satisfied a restriction linked to the trade. Exception report 807 includes rule violated column 834. Rule violated column 834 identifies the rule that has been violated by the trade. Rule violated column 834 may include one of rule names listed in column 804 of rules table 803.

Detail column 836 includes information explaining why a trade violated a rule. Additional information column 838 may identify a date of the violation or other suitable information.

Thus, apparatus and methods for automated model restriction verification have been provided. Persons skilled in the art will appreciate that the present invention can be practiced by other than the described embodiments, which are presented for purposes of illustration rather than of limitation. The present invention is limited only by the claims that follow.

What is claimed is:

1. A trading system for executing a trade, the system comprising a non-transitory computer-readable medium storing computer-executable instructions which, when executed by a processor on a computer system, perform a method for validating the trade, the computer-executable instructions configured to cause the computer system to:
receive a request to trade an instrument, the trade based on:
a set of contractual terms;
an output of a model computing a property of the instrument;
identify a lexical item associated with a restriction imposed on the model; and
determine a member of the set of contractual terms corresponding to the lexical item; and
determine compliance of the trade with the restriction by evaluating a formula based on the member of the set of contractual terms.

2. The system of claim 1 the computer-executable instructions further configured to cause the computer system to:
execute the trade when the evaluating of the formula returns a Boolean value corresponding to “true”; and
flag the trade when the evaluating of the formula returns a Boolean value corresponding to “false.”

3. The trading system of claim 1 wherein the set of contractual terms comprise:
an underlying asset;
a maturity date; and
an underlying currency.

4. The trading system of claim 1, the computer-executable instructions further configured to cause the computer system to:
identify the lexical item associated with the restriction by reading a rules table; and
identify the formula associated with the restriction by reading the rules table.

5. The trading system of claim 4, wherein the lexical item corresponds to:
a payoff currency range;
a time to maturity range; or
an interest rate range

6. The trading system of claim 4 wherein the lexical item is one of a plurality of lexical items and the rules table comprises a plurality of restrictions, the rules table links each of the plurality of restrictions to at least one of the plurality of lexical items.

7. The system of claim 4, the computer-executable instructions further configured to cause the computer system to:
receive a change to the formula; and
evaluate the formula based on the change.

8. The system of claim 7 wherein the change corresponds to a deletion of a member from a set of entries associated with the formula.

9. The system of claim 7 wherein the change corresponds to an addition of a member to a set of entries associated with the formula.

10. The trading system of claim 1 further comprising a lexical table linking the lexical item to the computer-executable instructions configured to cause the computer system to determine the member of the set of contractual terms corresponding to the lexical item.

11. A trading system configured to:
receive, from a line-of-business (“LOB”), a request to trade an instrument, the request comprising a first property of the instrument determined by a model;
in response to receiving the request, execute a first function call configured to:
identify a restriction on using the model to determine the first property of the instrument;
identify a lexical item associated with the restriction; and
identify a second function call corresponding to the lexical item;
execute the second function call, the second function call configured to:
determine a second property of the instrument corresponding to the lexical item; and
transfer the second property to a third function call; and
execute the third function call, the third function call configured to:
identify a formula corresponding to the restriction;
evaluate the formula based on the second property of the instrument; and
determine a compliance of the trade request with the restriction based on an output of the formula.

12. The system of claim 11 wherein the lexical item is one of a plurality of lexical items stored in a lexical items table, wherein for each of the plurality of lexical items:
the second function call is configured to identify the second property corresponding to each of the plurality of lexical items; and
the third function call is configured to:
identify the formula that is linked to each of the plurality of lexical items; and
evaluate the formula that is linked to each to each of the plurality of lexical items based on the second property corresponding to each of the plurality of lexical items.

13. The system of claim 12, wherein the lexical items table comprises a conditional rank corresponding to an order in which the second function call is configured to identify the second property corresponding to each of the plurality of lexical items and pass the second property to the third function call.

14. The system of claim 11, further comprising a rules table, wherein the rules table links:
the restriction to the formula; and
the lexical item to the restriction.

15. The trading system of claim 14 further configured to adjust the restriction by changing the formula linked to the lexical item.

16. The system of claim 11, wherein the request is a first request, the instrument is a first instrument and the model is a first model, the system is further configured to:
receive, a second request to trade a second instrument, the second request comprising a first property of the second instrument determined by a second model;
execute the first function call configured to:
identify, in response to receiving the second trade request, the lexical item in the second trade request;
identify the second function call corresponding to the lexical item;
execute the second function call, the second function call configured to determine a second property of the second instrument corresponding to the lexical item and pass the second property to the third function call; and
execute the third function call, the third function call configured to:
identify the formula linked to the lexical item and corresponding to the restriction on using the model to determine the first property of the second instrument; and
evaluate the formula based on the second property of the second instrument; and
determine a compliance of the second trade request with the restriction based on an output of the formula.

17. The trading system of claim 12 further configured to receive an adjusted trade request from the LOB, and in response to receiving the adjusted trade request:
add at least one row to the lexical items table; or
delete at least one row from the lexical items table.

18. An electronic trading platform configured to:
store an instrument and a restriction associated with the instrument; and
in response to a receiving a trade based on the instrument:
identify, in a lexical items table, at least one lexical item associated with the restriction;
obtain a property of the trade corresponding to the at least one lexical item;
using the property, compute an output of a formula corresponding to the restriction; and
based on the output of the formula, determine if the trade violates a rule corresponding the restriction.

19. The electronic trading platform of claim 18 wherein the property of the trade corresponds to:
a property of the trade; or
an activity associated with the trading event.

20. The electronic trading platform of claim 18 further configured to, when the lexical item is a first lexical item associated with the trade:
identify a second lexical item associated with the trading event;
based on the second lexical item:
obtain a second property of the trading event corresponding to the second lexical item; and
formulate a second trading restriction associated with the trading event based on the second property;
compute an output of the second trading restriction; and
based on the output of the second trading restriction, determine if the trading event violates a rule corresponding the second trading restriction.

21. The trading platform of claim 18 further configured to process trades for a plurality of lines-of-business (“LOBs”) operated by an entity, wherein each LOB shares the lexical items table.

22. The electronic trading platform of claim 18 further configured to:
receive an update to the trading restriction associated with the trading event;
amend the rule corresponding to the trading restriction;
compute the output of the trading restriction based on the amended rule; and
based on the output determine if the trading event violates the amended rule corresponding the trading restriction.

23. The trading system of claim 18, wherein when a plurality of lexical items are stored in the lexical item table and a plurality of rules are stored in a rules table, the trading system is further configured to:
execute a first check comprising:
verifying that each lexical item stored in the lexical item table is associated with a valid variable type; and
if each lexical item is associated with a valid variable type, examine a sample entry associated with the lexical item and determine whether the sample entry corresponds to the valid variable type;
execute a second check comprising determining, for each lexical item stored in the lexical item table, whether the corresponding second function call that is configured to determine the property corresponding to the lexical item is defined in the given code context;
execute a third check comprising determining, for each lexical item stored in the lexical item table, whether the corresponding second function call that is configured to determine the property corresponding to the lexical item returns the valid variable type associated with the lexical item;
execute a fourth check comprising determining, whether for each rule stored in the rules table the lexical items used in the rule formulation is stored in the lexical item table; and
execute a fifth check comprising, for each rule stored in the rules table, evaluate the trading restriction corresponding to the rule using the sample entry and determine if the output of the trading restriction is a Boolean value.
